(19) United States
(12) Patent Application Publication
(10) Pub. No.: US 2009/0269953 A1
(43) Pub. Date: Oct. 29, 2009

(54) Mounting Structure of Interface Jack

(75) Inventors: Yuan-Hung Chang, Taipei City (TW); Yu-Nien Chen, Taipei City (TW); Chung-Chou Fan, Taipei City (TW); Cheng-Wen Huang, Taipei City (TW); Hui-Ching Tsai, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/212,957

(22) Filed: Sep. 18, 2008

(30) Foreign Application Priority Data
Apr. 28, 2008 (CN) 200810094850.7

(51) Int. Cl. H01R 12/00

(52) U.S. Cl. 439/83; 439/78

(57) ABSTRACT

A mounting structure of an interface jack includes an insulating housing, multiple electrical wires, a first metallic piece, a second metallic piece, and at least one third metallic piece. The insulating housing has an upper surface, a lower surface, a backside surface, a first lateral wall, a second lateral wall and an entrance. The entrance is communicated with a receptacle disposed within the insulating housing. The backside surface is connected with the upper surface, the lower surface, the first lateral wall and the second lateral wall. The electrical wires are arranged inside the insulating housing and extended out of the backside surface of the insulating housing. The first metallic piece is attached on the bottom surface of the first lateral wall. The second metallic piece is attached on the bottom surface of the second lateral wall. The third metallic piece is attached on the lower surface.

### FIELD OF THE INVENTION

The present invention relates to a mounting structure of an interface jack, and more particularly to a mounting structure of an interface jack by using surface mount technology.

### BACKGROUND OF THE INVENTION

A printed circuit board (PCB) is an essential component of all every electronic device. The printed circuit board is used to mechanically support and electrically connect electronic components to form a functional circuit module.

By printing, electroplating or etching means, for example, conductor patterns or traces are formed on a copper clad laminate (CCL) substrate. After related electronic components are soldered on the printed circuit board, these electronic components are electrically connected with each other through the conductor patterns or traces so as to form a printed circuit board assembly (PCBA). An example of the PCBA includes a motherboard disposed within a host computer.

Conventionally, a through-hole technology (THT) is used to mount electronic components on the printed circuit board. In the through-hole construction, the electronic components are placed on one side (also referred as a component side) of the printed circuit board, and the pins of the electronic components are inserted in corresponding through-holes of the printed circuit board and then soldered on the other side (also referred as a solder side) of the printed circuit board. Since a plurality of through-holes corresponding to the pins of the electronic components are drilled in the printed circuit board and the solder joints between the electronic components and the electronic components are very large, the through-hole technology is usually applied to the relatively low-density integrated circuits. In addition, the through-hole construction is only suitable to fabricate a single layered circuit board.

With increasing progress of fabricating integrated circuits, the semiconductor packages are developed toward minimization and high integration. As a consequence, the requirement of increasing the pin density of the semiconductor packages on the printed circuit board becomes more important. Recently, a surface mount technology (SMT) is gradually used to construct relatively high-density integrated circuits on the printed circuit board. The printed circuit board usually has flat solder pads without holes. In the surface mount construction, the electronic components are placed on solder pads on the one or both surfaces of the printed circuit board, and then the pins of the electronic components are electrically and mechanically fixed to the solder pads with molten solder paste. Since the electronic components may be mounted on both sides of the printed circuit board, the space utilization of the printed circuit board is increased. In addition, the electronic components are usually made physically small and lightweight, thereby allowing much higher circuit densities. Surface mounting lends itself well to a high degree of automation, so that the fabricating cost is also reduced.

As known, a serial advanced technology attachment (SATA) interface is a computer bus for transferring data between a computer and mass storage devices such as hard disc drives and optical disc drives. FIG. 1A is a schematic perspective view of a connector with a SATA interface (also referred as a SATA connector). The SATA connector principally comprises a SATA interface plug 120 and a SATA interface jack 10. When the SATA interface plug 120 is plugged into the SATA interface jack 10, multiple electrical wires arranged within the SATA interface plug 120 and the SATA interface jack 10 are contacted with each other. In addition, the electrical wires of the SATA interface jack 10 are extended out of the backside surface of the insulating housing thereof. The electrical wires of the SATA interface jack 10 may be soldered on corresponding solder pads on a printed circuit board (as shown in FIG. 1B) according to a surface mount technology (SMT).

FIG. 1B is a schematic perspective view illustrating the SATA interface jack mounted on a printed circuit board. FIG. 1C is a schematic front view of the SATA interface jack. Please refer to FIGS. 1B and 1C. The main body of the SATA interface jack 10 includes an insulating housing with an entrance 101. Via the entrance 101, the SATA interface plug 120 may be plugged into a receptacle 105 within the SATA interface jack 10. The insulating housing of the SATA interface jack 10 is usually made of plastic material and integrally formed into a piece. The insulating housing of the SATA interface jack 10 comprises an upper surface 100, a lower surface opposed to the upper surface 100, two lateral walls 102 and a backside surface 103. Multiple electrical wires 107 are arranged inside the insulating housing of the SATA interface jack 10 and extended out of the backside surface 103 of the insulating housing. In addition, two metallic pieces 106 have respective first connecting parts 1061 embedded into respective notches 110 in the bottom surfaces of the two lateral walls 102 such that respective second connecting parts 1062 of the two metallic pieces 106 are extended from the bottom surfaces of the two lateral walls 102. The electrical wires 107 of the SATA interface jack 10 are soldered on corresponding solder pads of a printed circuit board 105 according to the surface mount technology (SMT), so that the SATA interface jack 10 is electrically connected with the printed circuit board through signals or power lines. Similarly, the second connecting parts 1062 of the two metallic pieces 106 are soldered on corresponding solder pads of the printed circuit board 105 according to the surface mount technology (SMT) so as to facilitate fixing the SATA interface jack 10 on the printed circuit board 105. In other words, only three contact regions are existed between the SATA interface jack 10 and the printed circuit board 105.

Although the process of mounting the SATA interface jack 10 on the printed circuit board 105 is simple and time-saving, there are still some drawbacks. Since the contact area between the SATA interface jack 10 and the printed circuit board 105 is insufficient, the SATA interface jack 10 is often suffered from poor solderability. In a case that the SATA interface plug 120 is frequently plugged into or withdrawn from the SATA interface jack 10, the SATA interface jack 10 is readily disconnected from the printed circuit board 105 due to a strong impact.

Therefore, there is a need of providing an improved mounting structure of an interface jack to obviate the drawbacks encountered from the prior art.

### SUMMARY OF THE INVENTION

The present invention provides a mounting structure of an interface jack by using the surface mount technology, in which the contact area between the interface jack and a printed circuit board is increased and thus the interface jack is firmly fixed on the printed circuit board.

In accordance with an aspect of the present invention, there is provided a mounting structure of an interface jack. The mounting structure includes an insulating housing, multiple electrical wires, a first metallic piece, a second metallic piece, and at least one third metallic piece. The insulating housing has an upper surface, a lower surface, a backside surface, a first lateral wall, a second lateral wall and an entrance. The entrance is communicated with a receptacle within the insulating housing. The backside surface is connected with the upper surface, the lower surface, the first lateral wall and the second lateral wall. The electrical wires are arranged inside the insulating housing and extended out of the backside surface of the insulating housing. The first metallic piece is attached on the bottom surface of the first lateral wall. The second metallic piece is attached on the bottom surface of the second lateral wall. The third metallic piece is attached on the lower surface.

In accordance with another aspect of the present invention, there is provided a SATA interface jack. The SATA interface jack includes an insulating housing, multiple electrical wires, a first metallic piece, a second metallic piece, and at least one third metallic piece. The insulating housing has an upper surface, a lower surface, a backside surface, a first lateral wall, a second lateral wall and an entrance. The entrance is communicated with a receptacle within the insulating housing. The backside surface is connected with the upper surface, the lower surface, the first lateral wall and the second lateral wall. The electrical wires are arranged inside the insulating housing and extended out of the backside surface of the insulating housing. The first metallic piece is attached on the bottom surface of the first lateral wall. The second metallic piece is attached on the bottom surface of the second lateral wall. The third metallic piece has a first connecting part to be embedded into a notch in the lower surface such that a second connecting part of the third metallic piece lies flat on the lower surface of the insulating housing.

In accordance with another aspect of the present invention, there is provided a SATA interface jack. The SATA interface jack includes an insulating housing, multiple electrical wires, a first metallic piece, a second metallic piece, and at least one third metallic piece. The insulating housing has an upper surface, a lower surface, a backside surface, a first lateral wall, a second lateral wall and an entrance. The entrance is communicated with a receptacle within the insulating housing. The backside surface is connected with the upper surface, the lower surface, the first lateral wall and the second lateral wall. The electrical wires are arranged inside the insulating housing and extended out of the backside surface of the insulating housing. The first metallic piece is attached on the bottom surface of the first lateral wall. The second metallic piece is attached on the bottom surface of the second lateral wall. The third metallic piece has a first connecting part embedded into a notch in the lower surface and an intermediate part sustained against the inner surface of the insulating housing such that a second connecting part of the third metallic piece lies flat on the lower surface of the insulating housing.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic perspective view of a SATA connector;

FIG. 1B is a schematic perspective view illustrating the SATA interface jack mounted on a printed circuit board;

FIG. 1C is a schematic front view of the SATA interface jack;

FIGS. 2A and 2B are schematic perspective views illustrating an insulating housing of a SATA interface jack taken from different viewpoints according to a preferred embodiment of the present invention;

FIGS. 2C and 2D are schematic front views illustrating the relations between two lateral metallic pieces and the insulating housing of the SATA interface jack;

FIGS. 2E and 2F are schematic bottom views illustrating the relations between an exemplary third metallic pieces and the insulating housing of the SATA interface jack;

FIGS. 2G and 2H are schematic bottom views illustrating the relations between another exemplary third metallic pieces and the insulating housing of the SATA interface jack; and

FIG. 3 is a schematic perspective view illustrating the SATA interface jack mounted on a printed circuit board according to a surface mount technology.

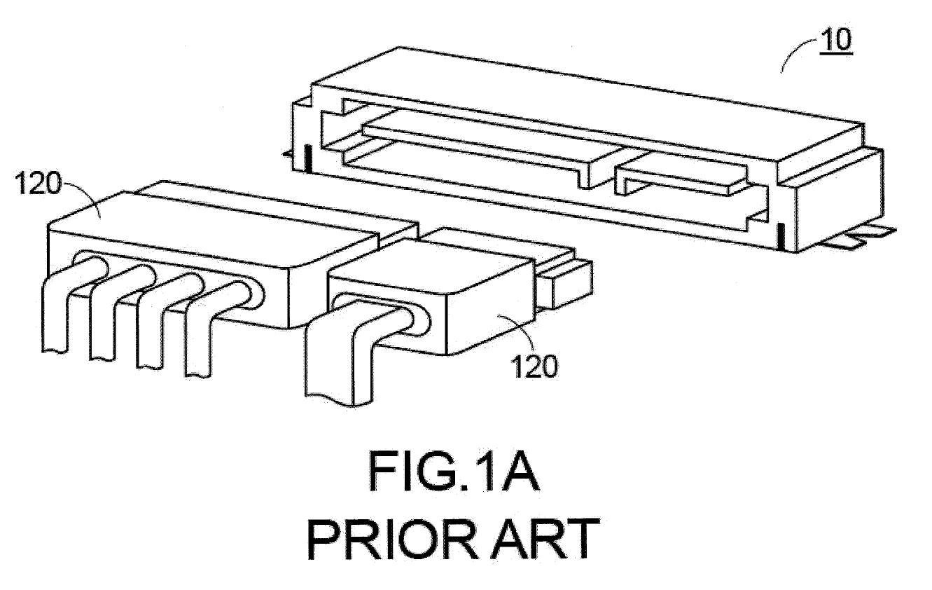

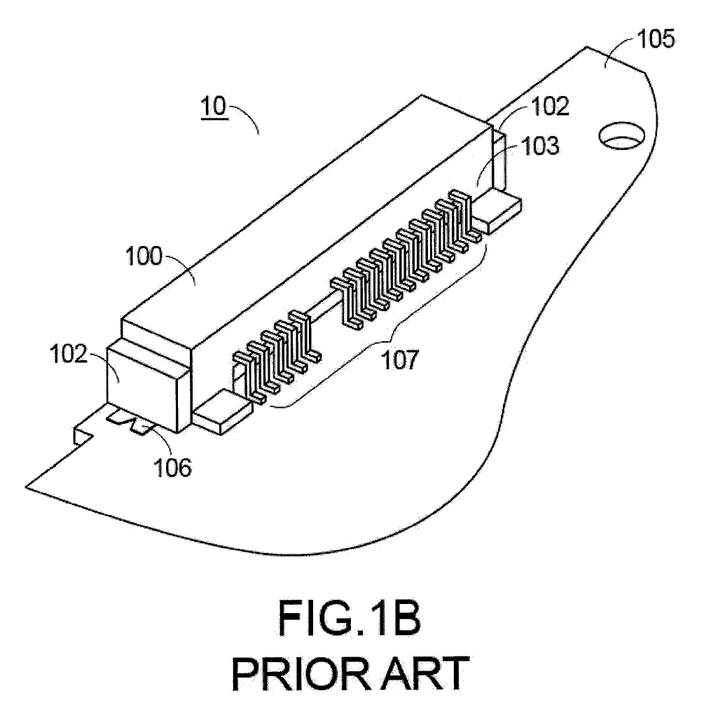

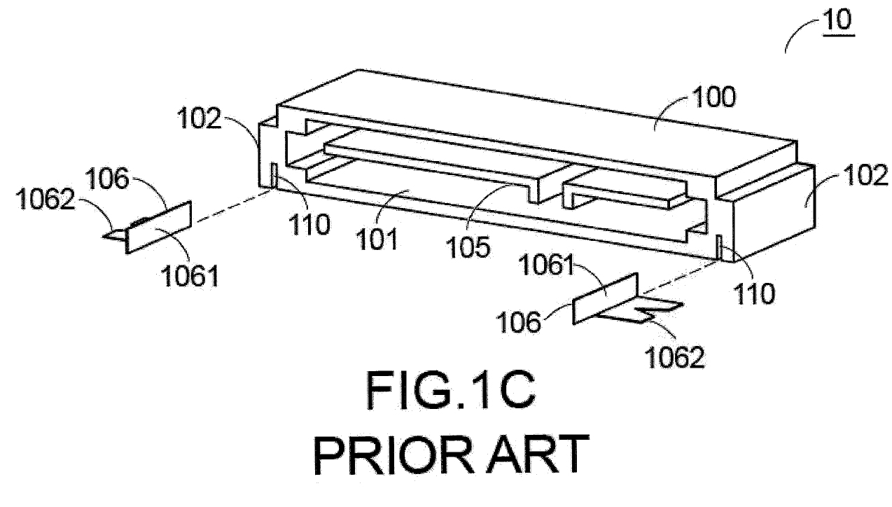

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

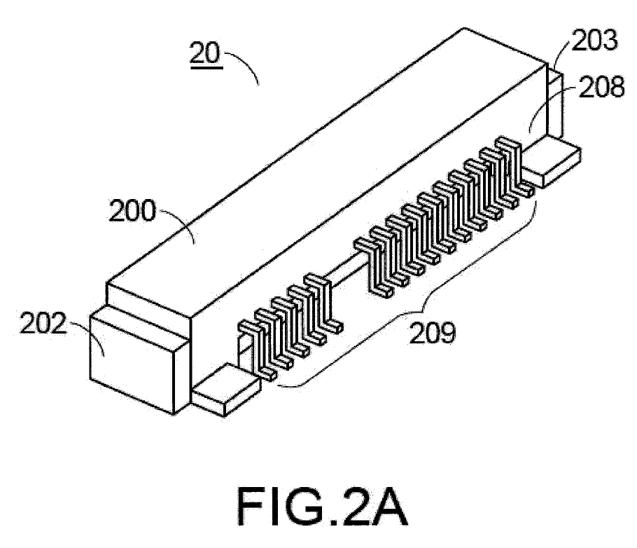

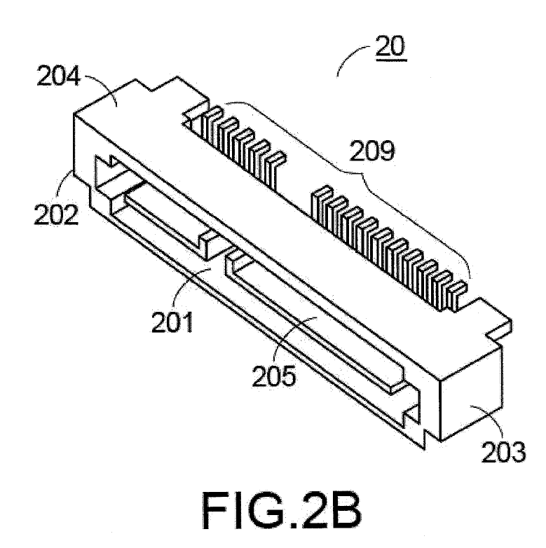

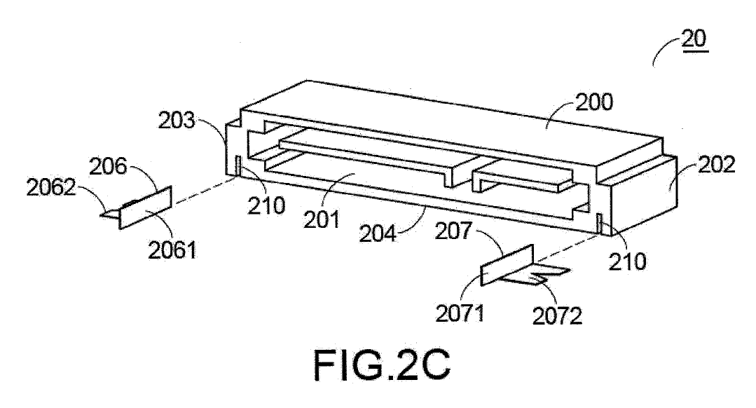

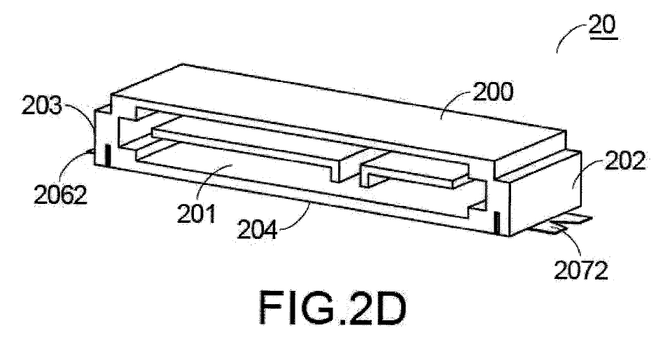

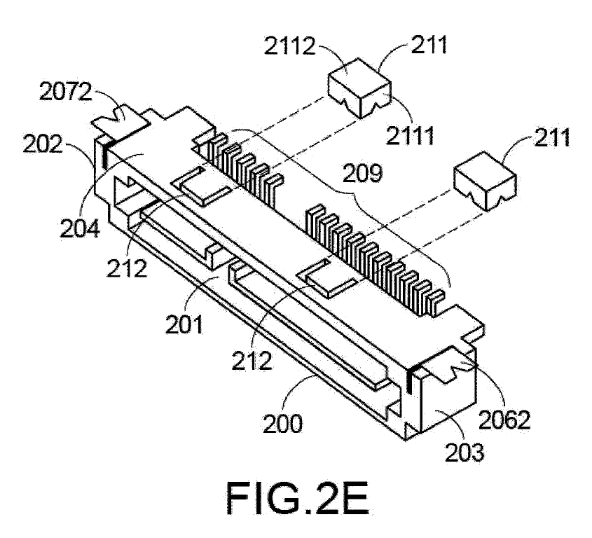

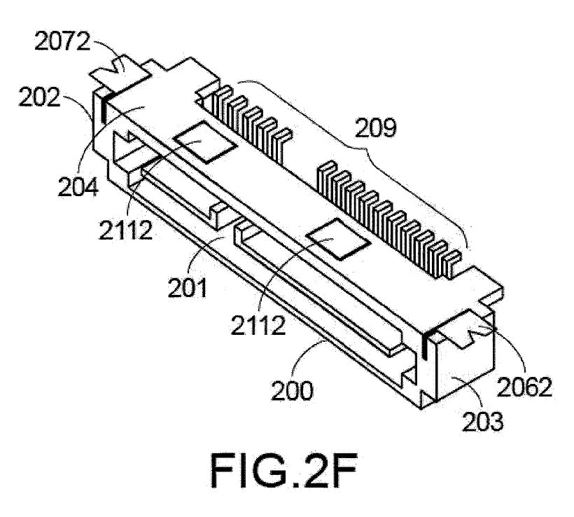

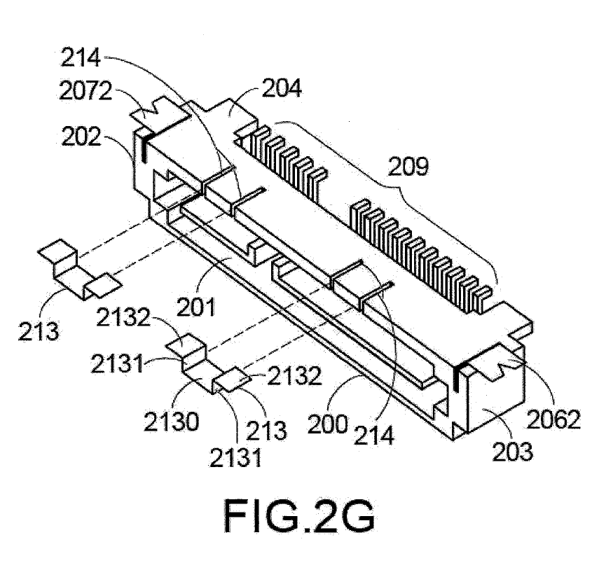

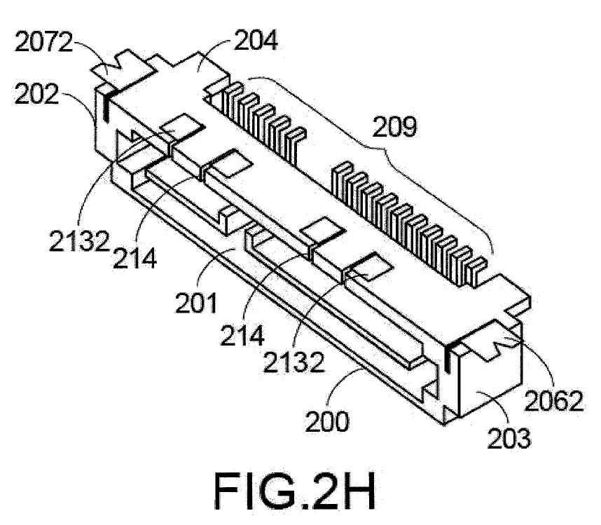

FIGS. 2A and 2B are schematic perspective views illustrating an insulating housing of a SATA interface jack taken from different viewpoints according to a preferred embodiment of the present invention. As shown in FIGS. 2A and 2B, the main body of the SATA interface jack 20 includes an insulating housing with an entrance 201. Via the entrance 201, a SATA interface plug (not shown) may be plugged into a receptacle 205 within the SATA interface jack 20. The insulating housing of the SATA interface jack 20 is usually made of plastic material and integrally formed into a piece. The insulating housing of the SATA interface jack 20 comprises an upper surface 200, a lower surface 204, a first lateral wall 203, a second lateral wall 202 and a backside surface 208. Multiple electrical wires 209 are arranged inside the insulating housing of the SATA interface jack 20 and extended out of the backside surface 208 of the insulating housing.

FIGS. 2C and 2D are schematic front views illustrating the relations between two lateral metallic pieces and the insulating housing of the SATA interface jack. As shown in FIG. 2C, two notches 210 are formed in the bottom surfaces of the two lateral walls 203 and 202, respectively. Corresponding to the notches 210, a first metallic piece 206 and a second metallic piece 207 have respective first connecting parts 2061, 2071 to be embedded into respective notches 210. Consequently, respective second connecting parts 2062, 2072 of the first and second metallic pieces 206, 207 are extended from the bottom surfaces of the lateral walls 203 and 202 as shown in FIG. 2D.

FIG. 2E is a schematic bottom view of the SATA interface jack of the present invention. In accordance with a key feature of the present invention, two notches 212 are formed in the lower surface 204. Corresponding to the notches 212, two third metallic pieces 211 have respective first connecting parts 2111 to be embedded into respective notches 212. Consequently, respective second connecting parts 2112 of the third metallic pieces 211 lie flat on the lower surface 204 as shown in FIG. 2F.

FIG. 2G is a schematic bottom view illustrating a variation of the SATA interface jack of the present invention. In this embodiment, two pairs of notches 214 are formed in the lower surface 204. Corresponding to the notches 214, two third metallic pieces 213 have respective first connecting parts 2131 to be embedded into respective notches 214 and respective intermediate parts 2130 to be sustained against the inner surface of the insulating housing 200. Consequently, respective second connecting parts 2132 of the third metallic pieces 213 lie flat on the lower surface 204 as shown in FIG. 2H.

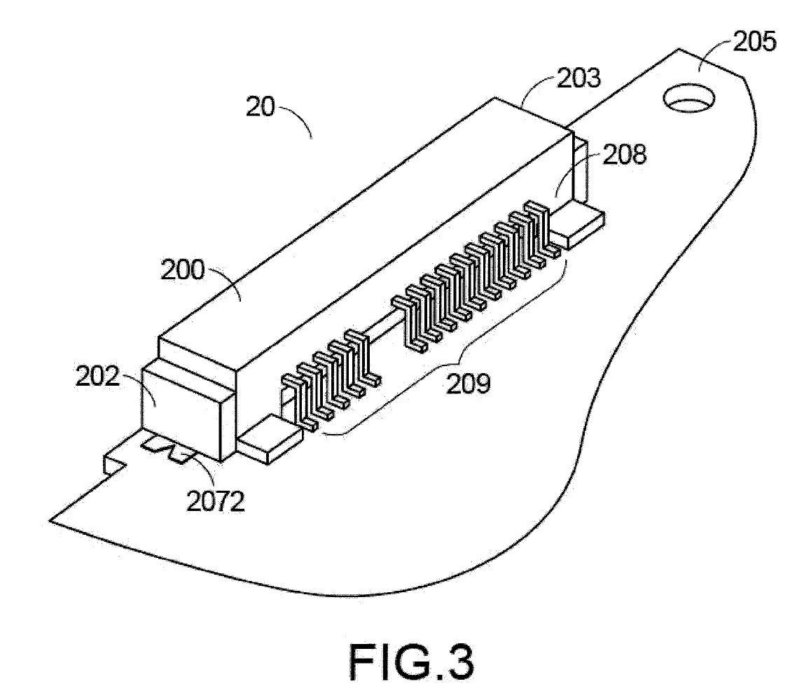

FIG. 3 is a schematic perspective view illustrating the SATA interface jack mounted on a printed circuit board 205 according to surface mount technology (SMT). Besides the first metallic piece 206, the second metallic piece 207 and the electrical wires 209, the SATA interface jack 20 of the present invention has additional contact regions to be soldered on corresponding solder pads of the printed circuit board 205. These additional contact regions are, for example, the second connecting parts 2112 of the third metallic pieces 211 (as shown in FIG. 2F) or the second connecting parts 2132 of the third metallic pieces 213 (as shown in FIG. 2H). Since the contact area between the SATA interface jack 20 and the printed circuit board 205 is increased, the SATA interface jack 20 can withstand stronger impact. Under this circumstance, even if the SATA interface plug is frequently plugged into or withdrawn from the SATA interface jack 20, the SATA interface jack 20 is still firmly fixed on the printed circuit board 205.

In the above embodiments, the third metallic pieces 211 and 213 are attached on the lower surface 204 of the SATA interface jack 20 by embedding respective first connecting parts 2111 and 2131 into corresponding notches 212 and 214. Nevertheless, the third metallic pieces may be attached on the lower surface 204 of the SATA interface jack 20 by an insert molding process or by screwing.

From the above description, the use of the third metallic pieces may increase the solderable area of the SATA interface jack, so that the SATA interface jack of the present invention is capable of firmly fixed on the printed circuit board.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A mounting structure of an interface jack, the mounting structure comprising:
an insulating housing having an upper surface, a lower surface, a backside surface, a first lateral wall, a second lateral wall and an entrance, wherein the entrance is communicated with a receptacle disposed within the insulating housing, the backside surface is connected with the upper surface, the lower surface, the first lateral wall and the second lateral wall;
multiple electrical wires arranged inside the insulating housing and extended out of the backside surface of the insulating housing;
a first metallic piece attached on the bottom surface of the first lateral wall;
a second metallic piece attached on the bottom surface of the second lateral wall; and
at least one third metallic piece attached on the lower surface.

2. The mounting structure according to claim 1 wherein the insulating housing is made of plastic material.

3. The mounting structure according to claim 1 wherein the first and second metallic pieces have respective first connecting parts to be embedded into corresponding notches in the bottom surfaces of the first and second lateral walls such that respective second connecting parts of the first and second metallic pieces are extended from the bottom surface of the first and second lateral walls.

4. The mounting structure according to claim 1 wherein the electrical wires, the first metallic piece, the second metallic piece and the third metallic piece are fixed on a printed circuit board.

5. The mounting structure according to claim 4 wherein the electrical wires, the first metallic piece, the second metallic piece and the third metallic piece are soldered on a printed circuit board according to the surface mount technology.

6. The mounting structure according to claim 1 wherein the third metallic piece has a first connecting part to be embedded into a notch in the lower surface such that a second connecting part of the third metallic pieces lies flat on the lower surface of the insulating housing.

7. The mounting structure according to claim 1 wherein the third metallic piece has a first connecting part to be embedded into a notch in the lower surface and an intermediate part of the third metallic piece sustained against the inner surface of the insulating housing such that a second connecting part of the third metallic piece lies flat on the lower surface of the insulating housing.

8. The mounting structure according to claim 1 wherein the third metallic piece is attached on the lower surface by insert molding.

9. The mounting structure according to claim 1 wherein the third metallic piece are attached on the lower surface by screwing.

10. The mounting structure according to claim 1 wherein the interface jack is a SATA interface jack.

11. A SATA interface jack comprising:
an insulating housing having an upper surface, a lower surface, a backside surface, a first lateral wall, a second lateral wall and an entrance, wherein the entrance is communicated with a receptacle disposed within the insulating housing, the backside surface is connected with the upper surface, the lower surface, the first lateral wall and the second lateral wall;
multiple electrical wires arranged inside the insulating housing and extended out of the backside surface of the insulating housing;
a first metallic piece attached on the bottom surface of the first lateral wall;
a second metallic piece attached on the bottom surface of the second lateral wall; and
at least one third metallic piece having a first connecting part to be embedded into a notch in the lower surface such that a second connecting part of the third metallic piece lies flat on the lower surface of the insulating housing.

12. The SATA interface jack according to claim 11 wherein the first and second metallic pieces have respective first connecting parts to be embedded into corresponding notches in the bottom surfaces of the first and second lateral walls such that respective second connecting parts of the first and second metallic pieces are extended from the bottom surface of the first and second lateral walls.

13. The SATA interface jack according to claim 11 wherein the electrical wires, the first metallic piece, the second metallic piece and the third metallic piece are fixed on a printed circuit board.

14. The SATA interface jack according to claim 13 wherein the electrical wires, the first metallic piece, the second metallic piece and the third metallic piece are soldered on a printed circuit board according to the surface mount technology.

15. A SATA interface jack comprising:
an insulating housing having an upper surface, a lower surface, a backside surface, a first lateral wall, a second lateral wall and an entrance, wherein the entrance is communicated with a receptacle disposed within the insulating housing, the backside surface is connected with the upper surface, the lower surface, the first lateral wall and the second lateral wall;
multiple electrical wires arranged inside the insulating housing and extended out of the backside surface of the insulating housing;
a first metallic piece attached on the bottom surface of the first lateral wall;
a second metallic piece attached on the bottom surface of the second lateral wall; and
at least one third metallic piece having a first connecting part to be embedded into a notch in the lower surface and an intermediate part of the third metallic piece sustained against the inner surface of the insulating housing such that a second connecting part of the third metallic piece lies flat on the lower surface of the insulating housing.

16. The SATA interface jack according to claim 15 wherein the first and second metallic pieces have respective first connecting parts embedded into corresponding notches in the bottom surfaces of the first and second lateral walls such that respective second connecting parts of the first and second metallic pieces are extended from the bottom surface of the first and second lateral walls.

17. The SATA interface jack according to claim 15 wherein the electrical wires, the first metallic piece, the second metallic piece and the third metallic piece are fixed on a printed circuit board.

18. The SATA interface jack according to claim 17 wherein the electrical wires, the first metallic piece, the second metallic piece and the third metallic piece are soldered on a printed circuit board according to the surface mount technology.
